(19) United States
(12) Patent Application Publication
(10) Pub. No.: US 2012/0230673 A1
(43) Pub. Date: Sep. 13, 2012

(54) MEASUREMENT OF ACCUMULATED CHROMATIC DISPERSION IN AN OPTICAL DATA TRANSMISSION NETWORK

(76) Inventors: Arne Striegler, Munchen (DE); David Stahl, Unterschleissheim (DE); Lutz Rapp, Deisenhofen (DE)

(21) Appl. No.: 13/505,587

(22) PCT Filed: Nov. 3, 2009
(86) PCT No.: PCT/EP2009/064511

§ 371 Date: May 23, 2012

(51) Int. Cl. H04B 10/08

(52) U.S. Cl. 398/16

(57) ABSTRACT

A method of measuring accumulated chromatic dispersion in an optical data transmission network includes the following method steps: a) sending a first bit pattern with at least one first pulse at a first wavelength and a second bit pattern with at least one second pulse at a second wavelength over an optical fiber; b) receiving the first bit pattern and the second bit pattern; c) determining a relative temporal shift between the first bit pattern and the second bit pattern; and d) calculating the accumulated chromatic dispersion from the relative temporal shift.

### FIELD OF THE INVENTION

The invention relates to a method of measuring accumulated chromatic dispersion in an optical data transmission network, an optical data transmission network using said method and a transmitter and a receiver adapted to carry out the method of the invention.

### TECHNICAL BACKGROUND

In an optical network the maximum transmission data rate is limited by a number of effects including chromatic dispersion. In particular, there is a significant interaction between dispersion and nonlinear fiber effects. Thus, performance does not depend on the accumulated chromatic dispersion at the end of a lightpath only, but there is a strong dependence on the distribution of dispersion within the lightpath.

As a consequence, dispersion management plays a fundamental role in achieving high data throughput and high transmission distances. A proper link design may result in low distortion caused by non-linear effects and may allow for reaching a maximum transmission distance together with a low bit-error rate. To find the optimum dispersion map, fiber data such as length, loss and accumulated chromatic dispersion have to be known as accurately as possible for planning the network. However, oftentimes exact fiber data are unavailable because of insufficient documentation of a given network or undocumented changes done to the network. For these reasons measurements have to be carried out in order to base network planning on reliable data. This is even more important where a network is maintained or expanded by a subcontractor of the network's owner which has to guarantee error-free network operation. Such measurements require time and may cost from several hundreds to more than thousand US$ or EUR because measurement equipment is expensive and measurement staff has to be present at the same time at both ends of a fiber span which may be far away from each other. A single light path may consist of several spans (typically between four and 20 spans) which need to be measured and characterized independently. Thus, such measurements require high efforts and cause operating cost. Nevertheless, spending these costs has been necessary since otherwise an increased number of costly regenerator sites will be introduced into the network in order to ensure proper network operation accounting for the risk of too optimistic assumptions when planning the network topology.

### SUMMARY OF THE INVENTION

Accordingly, a first aspect of the invention provides a method of measuring accumulated chromatic dispersion in an optical data transmission network. The method comprises steps of:
a) sending a first bit pattern comprising at least one first pulse at a first wavelength (λ1) and a second bit pattern comprising at least one second pulse at a second wavelength (λ2) over an optical fiber (11);
b) receiving the first bit pattern and the second bit pattern;
c) determining a relative temporal shift between the first bit pattern and the second bit pattern; and
d) calculating the accumulated chromatic dispersion from the relative temporal shift.

The invention is based on the insight that accumulated chromatic dispersion can be calculated from the relative temporal time shift that occurs when data is transmitted over the optical fiber at two different wavelengths. The method of the invention can be performed easily in a given optical network and allows for a very economic implementation when compared to previously known solutions.

The first bit pattern and the second bit pattern may be sent concurrently. This allows to determine the relative temporal shift directly at the receiver because the temporal relation of the two signals when sent by the sender is known.

Alternatively the first bit pattern and the second bit pattern are sent with a delay with regard to each other and determining a relative temporal shift includes:
e) determining whether the received first bit pattern and the received second bit pattern coincide temporally; and
f) changing the delay and continuing with step a) if the received first bit pattern and the received second bit pattern do not coincide temporally.

In this embodiment of the invention the two signals are sent repeatedly with varying delay. The relative temporal shift corresponds to the delay between the two signals at the sender for which both signals arrive concurrently at the receiver. While this embodiment allows for a simple construction of the receiver the sender has to be set up to control very small delays between bit patterns sent over the two different wavelengths which can be difficult to achieve.

In a preferred embodiment wherein the first and second bit patterns are sent concurrently, the first bit pattern comprises a train of first pulses and the second bit pattern comprises a train of second pulses. Generally the method of the invention can work with two bit patterns comprising only a single pulse each, however, the quality of the measurement is highly enhanced if repetitive patterns of higher duration are used. The method may further include detecting presence of an overlap between the first pulses and the second pulses.

An overlap between the first pulses and the second pulses is a time period during which optical power is received on both wavelengths. This embodiment of the invention is based on the idea that the pulse duration of the pulses is known and thus can form the basis of a time measurement wherein the presence or amount of overlap of pulses of the first bit pattern and the second bit pattern is evaluated.

In a preferred embodiment the received first bit pattern and the receiver second bit pattern are sampled into a sampled bit pattern and a frequency distribution of a sampled power level of the samples of the sampled bit pattern is analyzed in order to determine the relative temporal shift. In this embodiment the power level of the sampled bit pattern can be categorized into at least three categories: a) no or little optical power, b) optical power received on exactly one of the two wavelengths, c) optical power received on both wavelengths at the same time. The frequency distribution of the samples of the three categories is an indication for the amount of overlap between the two bit patterns at the receiver. However, if the form of the bit patterns is known (e.g. two alternating patterns of ones and zeros), the relative temporal shift between the two bit patterns at the receiver can be derived from the information about the number of occurrence of samples of the different categories.

Preferably analyzing the frequency distribution includes finding an extremum of the frequency distribution. The extremum can be interpreted to refer to a case where most or all first pulses overlap with second pulses when received at the receiver or to a case where few or no first pulses overlap with second pulses when received at the receiver. In either case since the pulse duration is known the relative temporal shift can be determined. The frequency distribution can be assessed for a plurality of different pulse durations in order to improve accuracy of the analysis.

Each of the first pulses and each of the second pulses may have predetermined pulse durations and may be spaced apart from each other by at least the predetermined pulse duration. The method may further comprise:
h) if an overlap between the first pulses and the second pulses is detected, changing the pulse duration and continuing with step a), wherein the relative temporal shift is determined to correspond to the pulse duration for which a minimum overlap has been detected.

This embodiment of the invention allows for a very simple implementation in hardware because only a decision is being made about whether an overlap exists or not. If no overlap exists, this means that one of the bit patterns is shifted with regard to the other such that all pulses of the bit pattern coincide with spaces between pulses of the other bit pattern. In this case the relative temporal shift can be derived directly from the pulse duration.

The train of second pulses may be a logic inverse of the train of first pulses. Then the relative temporal shift may be determined to correspond to the pulse duration for which a maximum overlap has been detected. This embodiment is based on a direct or indirect measurement of the duration of the overlap which can e.g. be realized by integrating the over-lapping parts of the received bit sequence.

The accumulated chromatic dispersion may be calculated by dividing the relative temporal shift by a difference between the first wavelength and the second wavelength.

If only the presence or absence of overlap is assessed, detecting presence of an overlap between the first pulses and the second pulses may comprise comparing a signal level of the received first and second pulses with a threshold. In this way the above-mentioned categories can be differentiated easily.

Preferably the threshold is set to be higher than an average signal level and lower than twice the average signal level.

Detecting presence of an overlap between the first pulses and the second pulses may comprise:
i) low-pass filtering of the received first and second pulses;
j) determining and storing a signal level of the low-pass filtered first and second pulses; and
k) comparing the signal level with previously stored signal levels and determining a maximum signal level among the signal levels, wherein the accumulated chromatic dispersion is calculated from the pulse duration corresponding to the maximum signal level.

Preferably the method may further comprise determining a sign of the accumulated chromatic dispersion. The sign of accumulated chromatic dispersion describes in which direction the relative temporal shift occurs depending on the difference between the wavelengths.

Preferably determining the sign of the accumulated chromatic dispersion comprises:
1) sending a third pulse at the first wavelength (λ1) and a fourth pulse at the second wavelength (λ2), the third pulse having a start time before a start time of the fourth pulse and overlapping the fourth pulse, an overlap time between the third pulse and the fourth pulse being less than or equal to the pulse duration;
m) receiving the third pulse and the fourth pulse;
n) determining whether the received third pulse and the received fourth pulse overlap; and
o) determining the sign of the accumulated chromatic dispersion based on a result of step n).

The underlying problem is similar to that of phase detection. In order to detect the sign, two pulses that overlap at the sender are used. The sign can be determined based on the presence or absence of overlap at the receiver. In one case the originally overlapping pulses will be moved apart and no overlap will remain, in the other case the pulses will be moved in the direction of the other pulse and will still overlap at the receiver.

Since accumulated chromatic dispersion need not be frequency-independent, the method may further comprise:
p) repeating the measurement replacing either the first wavelength (λ1) or the second wavelength (λ1) by a third wavelength (λ3) different from the first wavelength (λ1) and the second wavelength (λ2); and
q) determining a change of the accumulated chromatic dispersion as a function of wavelength (λ).

Depending on the number of wavelengths used, linear, quadratic a.s.o. dependence of accumulated chromatic dispersion may be modeled.

A second aspect of the invention provides an optical data transmission network comprising a transmitter and a receiver connected to the transmitter by means of an optical fiber, the transmitter and the receiver being adapted to carry out the method of the first aspect of the invention as well as the transmitter and the receiver adapted to do so.

### SHORT DESCRIPTION OF THE FIGURES

The invention will now be explained referring to several illustrative figures among which:

FIG. 1 shows an optical data transmission network according to the invention and exemplary signals used for measuring accumulated chromatic dispersion therein;

FIG. 2 comprises two sub-figures showing waveforms illustrating two possible results of a measurement step forming part of the measurement method according to a first preferred embodiment of the invention;

FIG. 3 shows waveforms illustrating the determination of the sign of the measured accumulated chromatic dispersion;

FIG. 4 illustrates a second preferred embodiment of the invention in three sub-figures; and

FIG. 5 shows examples for different chromatic dispersion characteristics and their respective measurement.

### DETAILED DESCRIPTION OF THE FIGURES

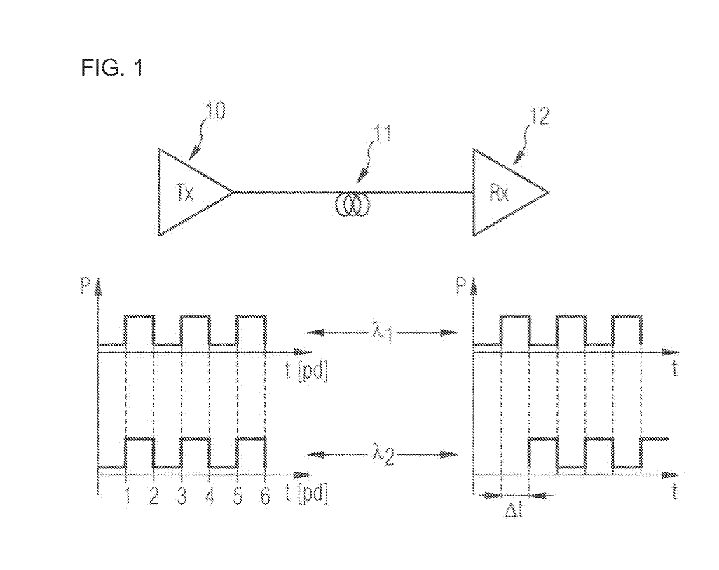

FIG. 1 shows an optical data transmission network according to the invention and exemplary signals used for measuring accumulated chromatic dispersion therein. A transmitter 10 is connected to a receiver 12 by means of an optical fiber 11.

Both the transmitter 10 and the receiver 12 can be monitoring devices connected to an optical amplifier (e.g. an EDFA) forming part of an optical light path of the optical data transmission network. However, it is also possible that the transmitter 10 and the receiver 12 are start and end points of an optical data transmission link.

FIG. 1 shows two sets of waveforms, each of which comprises one waveform showing optical power for a first wavelength λ₁ and one for a second wavelength λ₂ different from the first wavelength λ₁. In the first set of waveforms two pulse trains comprising a plurality of pulses are shown. The pulses have a duration of one unit pulse duration pd and are equally spaced apart from each other by the unit pulse duration pd. The pulses of both identical pulse trains are emitted concurrently such that they start at the same time and end at the same time when seen at the sender side. Due to chromatic dispersion along the travel through the optical fiber the pulse trains are shifted with respect to each other. The second set of waveforms illustrates this behavior. The pulses of light having the wavelength λ₁ are no longer temporally aligned with the light pulses of light having the wavelength λ₂ as they arrive at the receiver 12 because they are delayed by a time Δt which depends on their respective wavelengths. If this time Δt is measured, accumulated chromatic dispersion can be calculated by dividing Δt by the difference between λ₁ and λ₂:

D=Δt/Δλ=λΔ/(λ₂−λ₁)

The invention therefore provides a method wherein the relative temporal shift between two bit patterns is determined in order to measure the accumulated chromatic dispersion. Since the temporal shift is relative, it may be measured in two basic ways: either the bit patterns are sent concurrently and the resulting temporal shift is determined at the receiver or the bit patterns are sent with a mutual delay and it is determined whether the bit patterns are received concurrently. If the bit patterns are not received concurrently, the delay may be adjusted accordingly until the bit patterns are received concurrently for a given delay which correspond to the relative temporal shift.

However, Δt typically is in the range of tens to hundreds of picoseconds and needs to be measured with some measuring accuracy. Unfortunately measuring such very short times is difficult and thus costly. Preferred embodiments of the invention therefore provide for a method allowing for a simplified implementation of a measurement of accumulated chromatic dispersion.

According to a first embodiment of the invention two pulse trains of light of a first wavelength λ₁ and of a second wavelength λ₂ different from the first wavelength λ₁, respectively, are concurrently transmitted by the transmitter 10. The combined optical power of the two pulse trains is received at the receiver 12 and evaluated in order to detect the presence or absence of overlap between the pulses of the two pulse trains after they have travelled through the optical fiber 11. Depending on whether an overlap is present or not, the pulse duration is set to a different length and two new pulse trains are emitted, received and evaluated. Since accumulated chromatic dispersion depends on the wavelength and the physical network setup, it will remain constant as will Δt. However, as the pulse duration changes, so will the relative shift between pulses of the two pulse trains which may be determined by detecting an overlap between pulses of the respective pulse trains and derived from the known pulse duration.

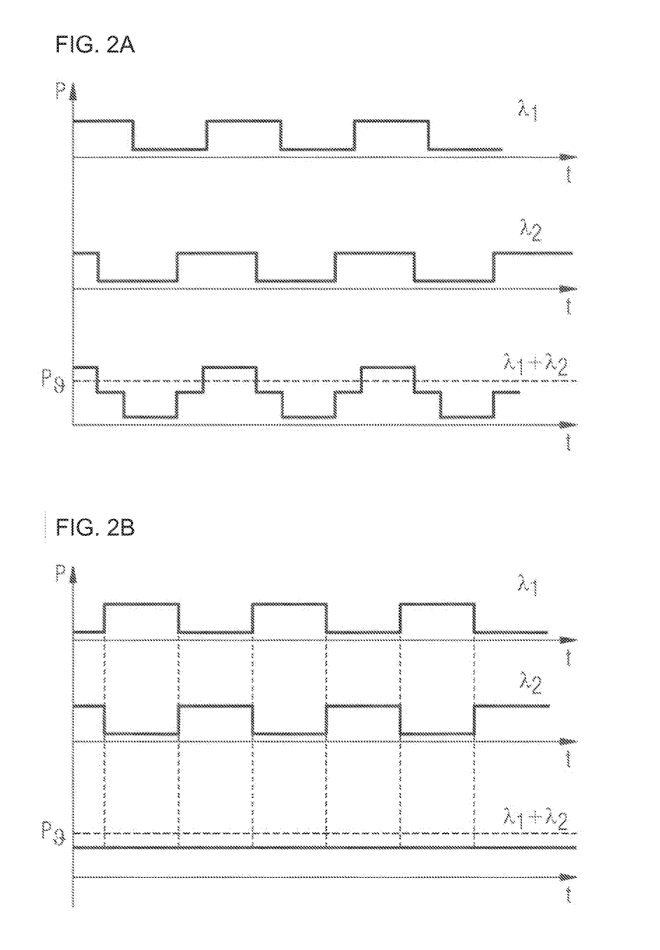

FIG. 2 comprises two sub-figures showing waveforms illustrating two possible results of a measurement step forming part of the measurement method according to the first embodiment of the invention. The sub-figures show three waveforms resulting from concurrently emitted pulse trains as shown in

FIG. 1 as they are received at the receiver 12. The first and second waveforms of both sub-figures show the optical power of the pulse trains of the first wavelength λ₁ and of the second wavelength λ₂, respectively, while the third waveform shows the combined power of the pulses of both pulse trains.

In the case of sub-figure a) the pulses of the first pulse train and those of the second pulse train overlap when they are received at the receiver 12. Thus, the combined power of received light at both wavelengths λ₁ and λ₂ reaches a maximum during times where the pulses overlap and a minimum where light of pulses of neither wavelength is received. The presence of overlap can e.g. be detected by comparing the received optical power with a threshold power P_{θ} which is set to be slightly higher than the average received optical power. As can be seen in sub-figure a), received optical power exceeds the threshold power P_{θ} during times where pulses of the respective pulse trains overlap.

Sub-FIG. 2 b) illustrates a second possible result of a measurement step. Here, pulses of the two wavelengths are shifted with regard to each other such that no overlap occurs between them. The combined optical power of both pulse trains remains below the threshold power P_{θ} during all times. Thus, it can be concluded that the relative delay Δt between the two pulse trains is equal to or shorter than the pulse duration. In the example of FIG. 2 the pulses of the pulse trains are spaced apart from each other by a pulse duration and, Δt is equal to the pulse duration such that combined optical power in sub-figure b) becomes constant. However, the invention is not limited to this configuration and pulses may also be spaced farther apart from each other. In such a case the threshold power P_{θ} should be set to be higher than the received optical power of any of the two pulse trains alone.

Δt can be determined easily by repeating the emission and reception using pulse trains having varying pulse durations. If an overlap is detected for a given pulse duration but not for a slightly shorter pulse duration, Δt can be assumed to correspond to the slightly shorter pulse duration or e.g. the mean value between the given pulse duration and the slightly shorter pulse duration and accumulated chromatic dispersion can be calculated. Thus, the method relies on finding the longest pulse duration for which the pulse trains do not show an overlap yet or on finding the shortest pulse duration for which the pulse trains still show an overlap (which are equivalent alternatives). Of course, a multitude of known search strategies can be applied such as linearly descending (i.e. starting at long pulse durations and decreasing the pulse duration), linearly ascending (starting at short pulse durations and increasing the pulse duration), non-linear search intervals e.g. based on choosing the incrementor/decrementor of the pulse duration based on the amount of overlap between the pulse trains and many more available to the person skilled in the art.

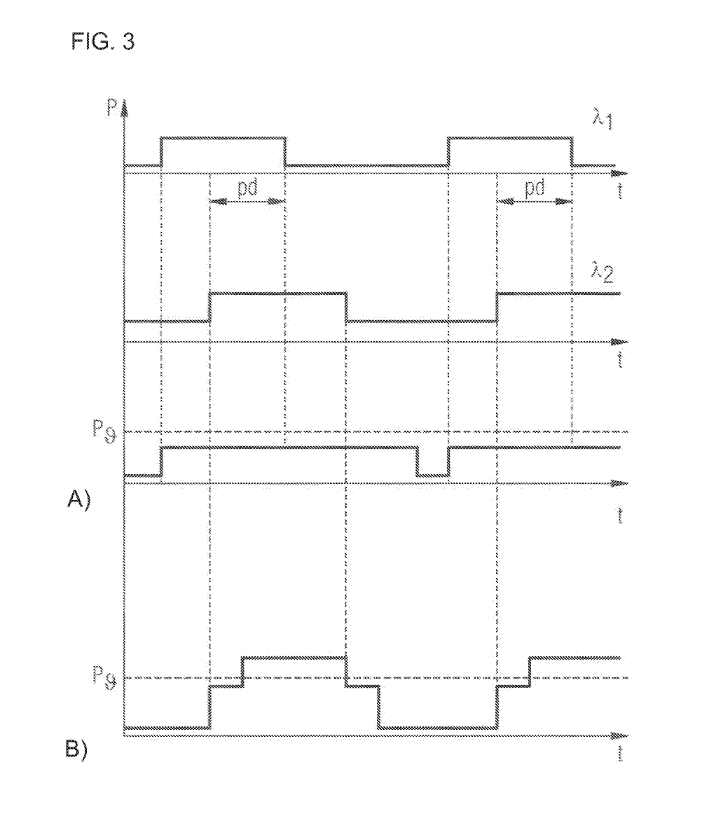

Accumulated chromatic dispersion may be either positive or negative, thus, it may be important to not only know Δt but also its sign and hence the sign of the accumulated chromatic dispersion. FIG. 3 shows waveforms illustrating the determination of the sign of the measured accumulated chromatic dispersion. The diagram comprises four waveforms among which the first and second show pulses emitted from the transmitter 10 at the first wavelength λ₁ and the second wavelength λ₂, respectively. The pulses are longer than the pulse duration pd determined by the above method and overlap each other by a time corresponding to the pulse duration pd determined by the above method. While a single pulse of each wavelength would be sufficient, the example of FIG. 3 shows a plurality of pulses for each wavelength which are spaced apart from each other such a distance between a pulse of the first wavelength λ₁ and a pulse of the second wavelength λ₂ is at least equal to or greater than the pulse duration pd. Since the pulses are longer than the pulse duration pd, a direction of shift between the two pulses may be determined.

The third and fourth waveforms show two possible (and mutually exclusive) results. The time of travel of light has been omitted such that the received pulses appear to coincide with the emitted pulses apart from the relative shift between the pulses of the respective waveforms.

In case a), the accumulated chromatic dispersion shifts the pulses with respect to each other such that no overlap remains between the pulses. However, since the pulses are longer than Δt as determined above, this means that the pulses of the second wavelength λ₂ have been delayed more than those of the first wavelength λ₁. In case b), on the other hand, an overlap between the pulses is detected at the receiver. This means that pulses of the first wavelength λ₁ are delayed more than those of the second wavelength λ₂. Thus, the sign of Δt can be determined using the same measurement equipment at the receiver as for the main measurement. If the pulse duration of the pulses shown in FIG. 3 is set to a multiple of the pulse duration as determined during the main measurement, e.g. to twice the pulse duration pd, while keeping the overlap at the transmitter one pd, it can be assured that the transmitter needs not be modified either.

Since the wavelengths λ₁ and λ₂ are known (or can be measured by a channel monitor for better accuracy, if present) and such is Δt, the accumulated chromatic dispersion and its sign can be measured using the transmitter and receiver used for normal communication. The method can be controlled via an optical supervisory channel which has been set up for communication of network equipment and through which the results of the measurement may be communicated to the respective other side of the transmission path.

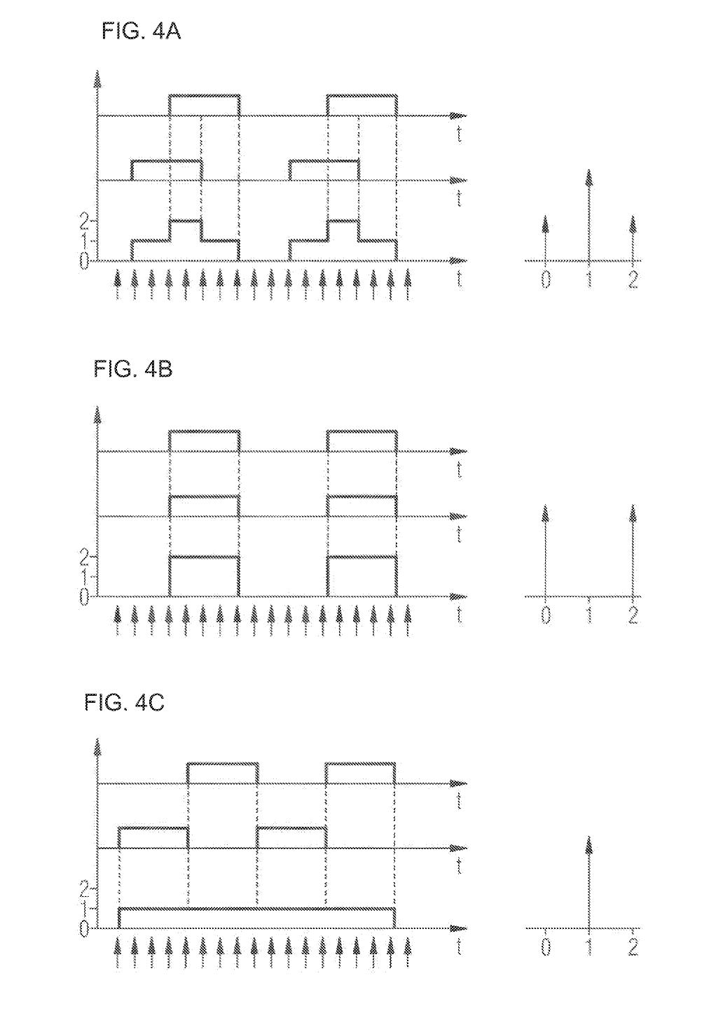

FIG. 4 illustrates a second preferred embodiment of the invention in the sub-figures. The three sub-figures of FIG. 4 each show first and second pulses and an overlay of the first and second pulses, all of them as received on the receiver. The example of FIG. 4 assumes that the first and second pulses were sent concurrently. The received first and second pulses (or rather their combined optical power) are sampled at the receiver which is indicated by a plurality of arrows. Of course, in a realistic set-up the first and second pulses would not be sampled with the high resolution shown in FIG. 4 but rather long pulse trains would be used which are sampled asynchronously, i.e. with a sampling rate that is not an integer fraction of the pulse rate of the first and second bit patterns. The samples are than categorized into representing no or very little optical power (neither a first nor second pulse was received at the sampling point), representing only optical power belonging to either a first or second pulse, or representing optical power of both a first and a second pulse (optical power of both pulses was received at the sampling point). Each sub-figure of FIG. 4 comprises a histogram which shows the frequency distribution of samples of the different categories. As can be seen for a duty cycle of 50% samples of the first and the last category (values of 0 and 2, respectively, in FIG. 4) will appear equally often. Of course, this will be different for other duty ratios. The number of samples in the second category (a value of 1 in FIG. 4) is complementary related to the number of samples in the first and last category. In order to determine the relative temporal shift the first and second pulses experience along their travel through the optical fiber, pulse trains of different pulse durations and/or duty cycles can be sent and the number of samples in each category can be determined. In the example of FIG. 4 it would be enough to determine the number of samples in only one category as the number of samples in the remaining categories can be derived from that. The relative temporal shift can be determined by looking for an extremum in the frequency of samples of one category. For the example of sub-figure c) the relative temporal shift corresponds to the pulse duration of the pulses which is indicated by a maximum number of samples in the second category (and by a minimum number of samples in the other two categories). The method can also be applied using complementary bit patterns. In this case a minimum number of samples in the second category or a maximum number of samples in the remaining categories would indicated that the actual pulse duration corresponds to the relative temporal shift (sub-figure b). The pulse duration corresponding to an extremum can be derived from a single measurement of a single pulse duration because the frequency of samples in the first and third category versus that of samples in the second category is linearly related to the relative temporal shift. Thus, it is possible to calculate the relative temporal shift from a frequency distribution as shown in sub-figure a) by calculating the ratio of the number of samples in the first or third category over the number of samples in the second category. This is also possible for duty cycles different from 50% but the calculation is slightly more complicated.

The second preferred embodiment of the invention is advantageous as it does not require any kind of clock-recovery because the sampling rate need not be related to the bit rate of the first and second bit patterns. While it is more complex than the first preferred embodiment, it is more robust and provides better measurement accuracy.

All embodiments of the invention can be carried out in an optical network including an optical transmission channel having multiple spans. A span usually comprises an optical fiber terminated by a receiver which receives the data signal transmitted over the optical fiber and amplifies the optical signal while forwarding it over the next span. Accordingly a single transmitter can be indirectly connected to a series of receivers which all may carry out the method of the invention in order to determine the accumulated chromatic dispersion that occurs during the transmission from the transceiver to the respective receiver. The results of the measurement for a preceding receiver may be subtracted from the result of the measurement for a given receiver in the data transmission thereby yielding an information about the chromatic dispersion occurring on a given span between the preceding receiver and the given receiver.

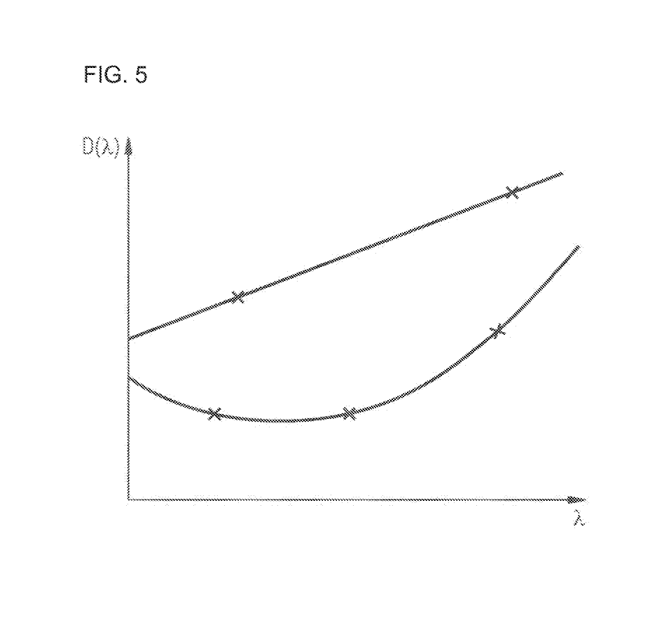

FIG. 5 shows examples for different chromatic dispersion characteristics and their respective measurement. Chromatic dispersion is a function of wavelength and may have different characteristics depending on the optical fiber used. E.g. the chromatic dispersion may depend linearly on wavelength or may show a quadratic form. Thus, it can be interesting to measure the accumulated chromatic dispersion for more than two wavelengths using the above method of measurement. As is well-known in the art, the number of measurements needs to be higher than the order of a polynomial used to described the relation between wavelength λ and chromatic dispersion D(λ). Thus, in order to determine the slope of a D(λ) showing linear dependence on the wavelength λ, two measurements using a total of three wavelengths will suffice while three measurements using at least four different wavelengths will be required to accurately model a quadratic dependence.

### REFERENCES

transmitter
optical fiber
receiver
λ.1 first wavelength
λ.3 third wavelength
pd pulse duration
D(λ.) chromatic dispersion

1-18. (canceled)

19. A method of measuring accumulated chromatic dispersion in an optical data transmission network, the method comprising:
a) sending a first bit pattern having at least one first pulse at a first wavelength and a second bit pattern having at least one second pulse at a second wavelength over an optical fiber;
b) receiving the first bit pattern and the second bit pattern;
c) determining a relative temporal shift between the first bit pattern and the second bit pattern; and
d) calculating the accumulated chromatic dispersion from the relative temporal shift.

20. The method according to claim 19, which comprises sending the first bit pattern and the second bit pattern concurrently.

21. The method according to claim 19, which comprises sending the first bit pattern and the second bit pattern with a delay with regard to each other, and wherein the step of determining the relative temporal shift includes:
e) determining whether the received first bit pattern and the received second bit pattern coincide temporally; and
f) changing the delay and continuing with step a) if the received first bit pattern and the received second bit pattern do not coincide temporally.

22. The method according to claim 20, wherein the first bit pattern comprises a train of first pulses and wherein the second bit pattern comprises a train of second pulses, and the method further comprises detecting a presence of an overlap between the first pulses and the second pulses.

23. The method according to claim 22, which comprises sampling the received first bit pattern and the received second bit pattern into a sampled bit pattern and analyzing a frequency distribution of a sampled power level of the samples of the sampled bit pattern to thereby determine the relative temporal shift.

24. The method according to claim 23, wherein the analyzing step comprises finding an extremum of the frequency distribution.

25. The method according to claim 22, wherein each of the first pulses and each of the second pulses have a predetermined pulse duration and are spaced apart from each other by at least the predetermined pulse duration, and wherein the method further comprises:
if an overlap between the first pulses and the second pulses is detected, changing the pulse duration and continuing with step a), wherein the relative temporal shift is determined to correspond to the pulse duration for which a minimum overlap has been detected.

26. The method according to claim 25, wherein the train of second pulses is a logic inverse of the train of first pulses and wherein the relative temporal shift is determined to correspond to the pulse duration for which a maximum overlap has been detected.

27. The method according to claim 19, which comprises calculating the accumulated chromatic dispersion by dividing the relative temporal shift by a difference between the first wavelength and the second wavelength.

28. The method according to claim 25, wherein detecting a presence of an overlap between the first pulses and the second pulses comprises comparing a signal level of the received first and second pulses with a threshold.

29. The method according to claim 28, which comprises setting the threshold to be higher than an average signal level and lower than twice the average signal level.

30. The method according to claim 25, wherein detecting a presence of an overlap between the first pulses and the second pulses comprises:
low-pass filtering of the received first and second pulses;
determining and storing a signal level of the low-pass-filtered first and second pulses; and
comparing the signal level with previously stored signal levels and determining a maximum signal level among the signal levels, and wherein the accumulated chromatic dispersion is calculated from the pulse duration corresponding to the maximum signal level.

31. The method according to claim 19, which further comprises determining a sign of the accumulated chromatic dispersion.

32. The method according to claim 31, wherein the step of determining the sign of the accumulated chromatic dispersion comprises:
sending a third pulse at the first wavelength and sending a fourth pulse at the second wavelength, the third pulse having a start time before a start time of the fourth pulse and overlapping the fourth pulse, an overlap time between the third pulse and the fourth pulse being less than or equal to the pulse duration;
receiving the third pulse and the fourth pulse;
determining whether the received third pulse and the received fourth pulse overlap; and
determining the sign of the accumulated chromatic dispersion based on a result of the step of determining whether the received third and fourth pulses overlap.

33. The method according to claim 19, which further comprises:
repeating the measurement and thereby replacing either the first wavelength or the second wavelength by a third wavelength different from the first wavelength and the second wavelength; and
determining a change of the accumulated chromatic dispersion as a function of wavelength.

34. An optical data transmission network, comprising a transmitter and a receiver connected to said transmitter by way of an optical fiber, said transmitter and said receiver being configured to carry out the method according to claim 19.

35. A transmitter for an optical data transmission network, configured to carry out the method according to claim 19 in cooperation with a receiver in the optical transmission network.

36. The receiver for an optical data transmission network, configured to carry out the method according to claim 19 in cooperation with a transmitter of the optical transmission network.
